(19) United States
(12) Patent Application Publication
(10) Pub. No.: US 2008/0281713 A1
(43) Pub. Date: Nov. 13, 2008

(54) TRANSACTION SETTLEMENT METHOD, TRANSACTION SETTLEMENT SYSTEM, TRANSACTION SETTLEMENT PROGRAM AND PROGRAM RECORDING MEDIUM

(75) Inventor: Masakazu ITO, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC Infrontia Corporation, Kanagawa (JP)

(21) Appl. No.: 12/117,412

(22) Filed: May 8, 2008

(30) Foreign Application Priority Data
May 9, 2007 (JP) 124097/2007

(51) Int. Cl. G06Q 20/00; H04L 9/32

(52) U.S. Cl. 705/18; 705/16

(57) ABSTRACT

Disclosed is a security protected transaction settlement method in performing transaction settlement of sales using a register terminal. The upper limit amount that each casher who operates the register terminal can settle is preset and registered in advance. When a casher makes settlements of the sales using the register terminal, a judgment is made if the casher can settle the transaction by comparing the sales amount and the upper limit amount preset for the casher. If the sales amount is higher than the preset upper limit amount, the register terminal is disabled and the casher can settle the transaction only if an authorization code is inputted by a supervisor who has authority to settle any account in excess of the upper limit.

### INCORPORATION BY REFERENCE

This application is based upon and claims the benefit of priority from Japanese patent application no. 2007-124097, filed on May 9, 2007, the disclosure of which is incorporated herein in its entirety by reference.

### FIELD OF THE INVENTION

This invention relates to a transaction settlement method, a transaction settlement system, a transaction settlement program and a program recording medium, more specifically to those provided with an approval function by an authority when the amount of money involving the transaction exceeds a predetermined upper limit.

### BACKGROUND OF THE INVENTION

Normally, when a casher makes a transaction settlement for any goods or foods and drinks purchased or consumed by a customer using a cash register or a POS terminal, there is no predetermined upper limit of the amount of money that the casher can handle. For example, when a casher settles a transaction involving a large amount of money, the casher is permitted to settle such transaction without any authority's approval or supervision even if the casher is inexperienced or even if the casher is dishonest. As a result, it is possible to encounter a security problem in the transaction settlement as disclosed in Japanese patent publication no. 8-124032 (see pages 3-5).

### SUMMARY OF THE INVENTION

In view of the aforementioned problem associated with prior art, it is the object of the present invention to preset the upper limit of the amount of money that can be settled and provide an authority's approval function in case of exceeding the preset upper limit, thereby providing a transaction settlement method that ensures high degree of security in transaction settlement operations.

In order to solve the aforementioned problem, the transaction settlement method, the transaction settlement system, the transaction settlement program and the program recording medium according to the present invention employ the following unique constructions:

(1) A transaction settlement method for settling sales using a register terminal, characterized in that the upper limit of the amount of money to be permitted to settle by each casher who operates the register terminal is registered by arbitrarily setting in advance.

(2) A transaction settlement method of the above (1), wherein if the amount of sales to be settled is in excess of the upper limit, an authorization level to indicate whether or not any sales in excess of the upper limit can be settled are registered in advance by arbitrarily setting for each casher.

(3) A transaction settlement method of the above (2), wherein the authorization level comprises plural levels of combinations of not only the capability of excess settlement but also capabilities of other items including settlement of minus amount of money, zero amount of money and cancellation of sales slips.

(4) A transaction settlement method of the above (1), wherein if the sales amount is in excess of the upper limit and the casher has no authority to make the excess settlement, an authorization code input display screen for prompting an alternative casher to input his/her authorization code is displayed on the screen of the register terminal.

(5) A transaction settlement method of the above (4), wherein the alternative casher is permitted to settle the sales in excess of the upper limit using the register terminal if the authorization code inputted by the alternative casher while the authorization code input display screen is displayed proves to be valid for making the settlement in excess of the upper limit.

(6) A transaction settlement method of the above (4), wherein if the authorization code inputted by the alternative casher is invalid for making the settlement in excess of the upper limit, no excess settlement procedures are carried out and an error message is displayed on the screen of the register terminal to indicate that he/she is not authorized to make the excess settlement.

(7) A transaction settlement method of the above (1), wherein at the time of making the settlement in excess of the upper limit, histories of information on the excess settlement are stored as a time sequence excess settlement report and a casher based excess settlement report for outputting in form of a list.

(8) A transaction settlement system for settling sales using a register terminal, characterized in the provision of means for arbitrarily registering in advance by setting upper limit of the amount of money that is permitted to settle by a casher who operates the register terminal.

(9) A transaction settlement system of the above (8), characterized in the provision of casher registration means for registering in advance an authorization level to indicate whether or not the casher is permitted to make a settlement if the sales amount is in excess of the upper limit by arbitrarily setting the upper limit for each casher who operates the register terminal.

(10) A transaction settlement system of the above (8), wherein an authorization code input display screen for prompting an alternative casher to input his/her authorization code is displayed on the register terminal if the sales amount exceeds the upper limit of the settlement amount and the casher has no authority to settle the account in excess of the upper limit.

(11) A transaction settlement system of the above (10) wherein the register terminal of the casher is permitted to make the settlement of the sales amount in excess of the upper limit only if the authorization code inputted in response to the authorization code input display screen is the authorization code of any person having the authority to settle the sales amount in excess of the upper limit.

(12) A transaction settlement system of the above (8), wherein at the time of making the settlement of any transaction in excess of the upper limit, histories on the excess settlements are accumulated for outputting in a list form a time sequence excess settlement report and/or an excess settlement report for each casher who operated the register terminal.

(13) A transaction settlement program for performing the transaction settlement method of the above (1) in form of a computer executable program.

(14) A program recording medium for recording the transaction settlement program of the above (13) in a computer readable recording medium.

The transaction settlement method, the transaction settlement system, the transaction settlement program and the program recording medium according to the present invention exhibit the following advantages:

Provision of the preset upper limit in transaction settlement in response to authorization levels given to each casher (or a person who handles transaction settlements) prevents the casher from settling any transaction in excess of the preset upper limit, thereby effectively preventing the casher from dishonestly receiving or paying money in and from the terminal.

In case of settling any transaction in excess of the preset upper limit, the casher's supervisor such as his/her manager or the like who has a higher level of authority is requested to present before the register terminal for inputting his/her authorization code (such as the employee code or the like), thereby enabling the supervisor such as the manager or the like to recognize the transaction in excess of the preset upper limit. This means that information such as the customers to whom any money in excess of the upper limit is paid is made available to the supervisor before actually settling the transaction. And such information may be used for other services before or after the transaction settlement.

### BRIEF DESCRIPTION OF THE DRAWINGS

In the accompanying drawings,

FIG. 1 is an exemplified table of the amount of money and the associated transaction settlement in the transaction settlement method according to the present invention;

FIG. 2 is an exemplified master table of employees master that registers employee codes for the persons who engages with transaction settlements;

FIG. 3 is an exemplified master table of authority level master that defines authorization levels for making transaction settlements;

FIG. 4 is a diagram of an exemplified sales display screen of a sales slip subjected to the transaction settlement;

FIG. 5 is a diagram of an exemplified employee code input display screen prompting input of the employee code;

FIG. 6 is a diagram of an exemplified error display screen notifying that the employee is not authorized to settle the transaction;

FIG. 7 is a diagram of an exemplified display screen indicating that the transaction settlement has been completed;

FIG. 8 is an exemplified transaction settlement report of a time sequence list of transactions in excess of the upper limit;

FIG. 9 is an exemplified casher based list of transactions in excess of the upper limit; and

FIG. 10 is a flowchart for describing an embodiment of the transaction settlement method according to the present invention.

### DETAILED DESCRIPTION OF EXEMPLARY EMBODIMENTS

Now, exemplary embodiments of the transaction settlement method, the transaction settlement system, the transaction settlement program and the program recording medium according to the present invention will be described with reference to the accompanying drawings. Although the following descriptions are made on the transaction settlement method and the transaction settlement system, it is to be noted that the transaction settlement method can be implemented in a form of a transaction settlement program that is executed by a computer or a transaction settlement program may be recorded in a recording medium that is readable by a computer.

### (Features of the Present Invention)

Prior to detailed description of embodiments of the present invention, unique features of the present invention will be generally described. When the casher who operates the cash register terminal pushes down its “settlement” button (or the “cash” key in case of a POS terminal) for the purpose of making the payment of sales in the present invention, a comparison is made between the amount of money to be settled (the amount of sales) and the preset upper limit permitted to settle by the casher. If the amount of money to be settled is in excess of the upper limit, an authorization code input display screen or image is displayed on the screen of the register terminal for prompting his/her supervisor who has higher authorization level than the casher to input the preset authorization code (e.g., employee code). The present invention features in that a settlement of transaction in excess of the upper limit is made valid only if the authorization code inputted by the supervisor is valid authorization code (e.g., an authorization code of his/her manager or the like) who is authorized to settle.

If any authorization code for a person having no authority to make the settlement is inputted while displaying the authorization code input image on the screen, an error image is displayed on the screen and no settlement can be made for any transaction in excess of the upper limit.

When settlements of any amount of money in excess of the upper limit have been made, prepared are “excessive settlements reports” that are lists of registered excessive settlements, thereby recording histories on information regarding settlements in excess of the upper limit. The “excessive settlements reports” include a time sequence excessive settlements report and a casher based settlements report. The former is a report to output information of sales slips in excess of the upper limit in the order of their occurrences. On the other hand, the latter is a report including columns of the preset amount of upper limit for each casher and the number of settlements made by each casher, thereby enabling to recognize the number of settlements made by each casher.

It is to be noted that the transaction settlement method according to the present invention should not be restricted only to cash payments. Similarly, it can be applied to payments by other means such as, for example credit cards, IC cards, gift coupons or the like.

### Embodiments of the Present Invention

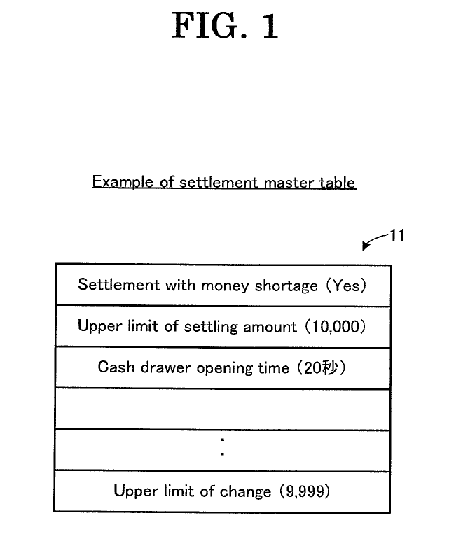

Now, exemplary embodiments of the present invention will be described with reference to FIGS. 1-4. FIG. 1 is an exemplified table for setting items relating to the amount of money, the way of payment and the like. In other words, it is a master table that stores preset information for transaction settlement. In the particular example that is preset in the settlement master table 11 as shown in FIG. 1, the casher is authorized to settle with money shortage (i.e., partial payment), the authorized upper limit of transaction is 10,000 units (for example, the unit is Yen), the cash drawer is open for 20 seconds and the upper limit for the change is 9,999 units. Accordingly, when making a Yes/No judgment in case of any transaction in excess of the upper limit, a comparison is made between the total amount of money to be settled and the upper limit of 10,000 units.

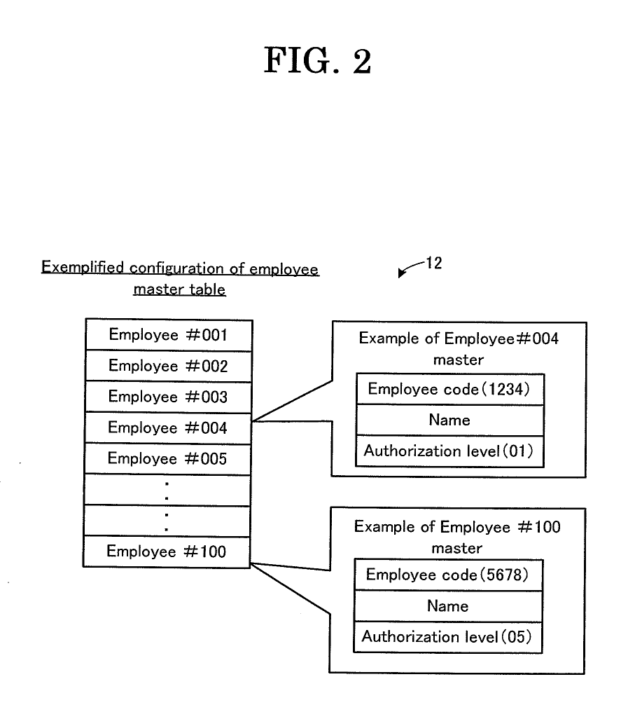

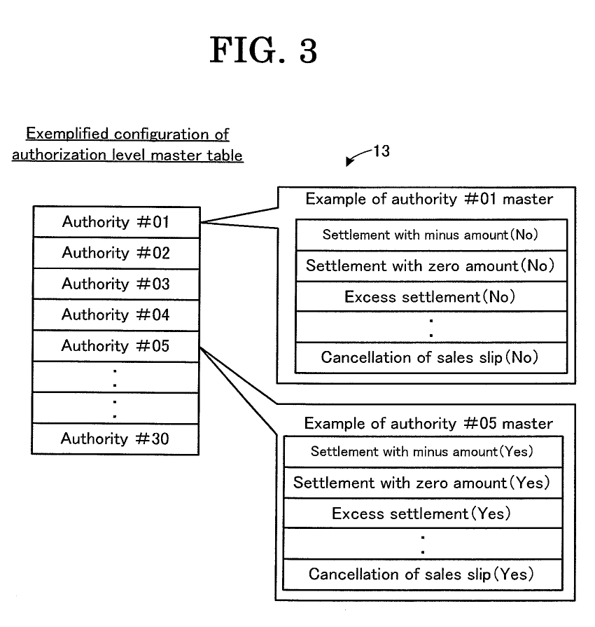

FIG. 2 is an exemplified employee master table for employees whose employee codes are registered as cashers for making transaction settlements. Registered in the master table are at least identification codes, for example employee codes that enable to identify respective cashers together with information including their names and authorization levels in transaction settlements. For example, in case of the employee master table 12 as shown in FIG. 2, registered in the employee master for the employee #004 are the employee code “1234” and the authorization level “#01”. On the other hand, the employee code “5678” and the authorization level “#05” are registered in the employee master for the employee #100. It is to be noted herein that the authorization levels relating to the transaction settlements are defined in an authorization level master table as shown in FIG. 3.

FIG. 3 is an exemplified master table of an authorization level master for defining the authorization levels for cashers who make transaction settlements. It defines for each authorization level various information including at least Yes/No of settlement with minus amount of money, Yes/No of settlement with zero amount of money, Yes/No of transaction settlements in excess of the upper limit, Yes/No of canceling sales slips and the like. For example, in case of the exemplified authorization level master table 13 as shown in FIG. 3, the casher of the authorization level “#01” is not permitted to settle transactions with minus amount of money, zero amount of money and in excess of the upper limit and also to cancel any sales slip. On the other hand, the casher of the authorization level “#05” is permitted to settle transactions with minus amount of money, zero amount of money and in excess of the upper limit and also to cancel any sales slip.

Accordingly, the employee #004 with the authorization level “#01” in the employee master table 12 as shown in FIG. 2 is not permitted to settle transactions with minus amount of money, zero amount of money and any transaction in excess of the upper limit and also to cancel any sales slip. However, the employee #100 with the authorization level “#05” in the employee master table 12 as shown in FIG. 2 is permitted to settle transactions with minus amount of money, zero amount of money and any transaction in excess of the upper limit and also to cancel any sales slip.

It is to be noted in the authorization master table 13 as shown in FIG. 3 that larger numbers of authorization level such as #30 do not necessarily mean to have higher authority level than the authorization level #01 (i.e., higher numbers of authorization level do not necessarily mean to have higher levels of authority). Yes/No for each item can be freely set to authorization levels #01-#30 as the authorization master table.

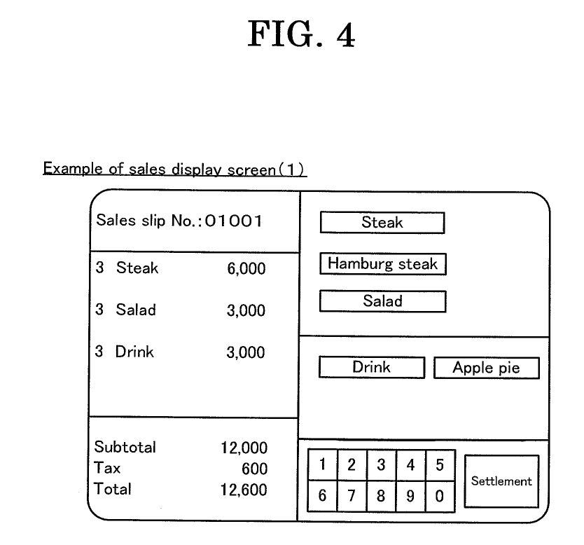

FIG. 4 is an exemplified illustration of a sales display screen representing an example of sales slip to be settled in the present invention. Displayed at the left side on the screen is the detail of the sales including the number of sales slip, the product name and the sales amount of money. On the other hand, displayed on the right side on the screen are “Product” and “Settlement” buttons. In the particular example of the sales display screen as shown in FIG. 4, a grand total of sales of 12,600 units is displayed on the sales screen. When the casher pushes down the “Settlement” button at the right side on the display screen, the total amount of sales 12,600 units to be settled is compared with the upper limit 10,000 units in the master table as shown in FIG. 1.

As shown in FIG. 4, when the total transaction price (i.e., the total amount of sales 12, 600 units) exceeds the upper limit (10,000 units) as preset in the master table 11 as shown in FIG. 1, a judgment is made to determine whether or not the casher who operates the register terminal has authority to settle the transaction in excess of the upper limit. Firstly, a reference is made to the employee master table 12 as shown in FIG. 2 for extracting the number of the authorization level of the casher that is registered in the employee master information. Based upon the extracted number of the authorization level and making a reference to the authorization level master table 13 as shown in FIG. 3, a judgment is made to set-up an Yes/No flag for settling the transaction in excess of the upper limit in authorization level master information.

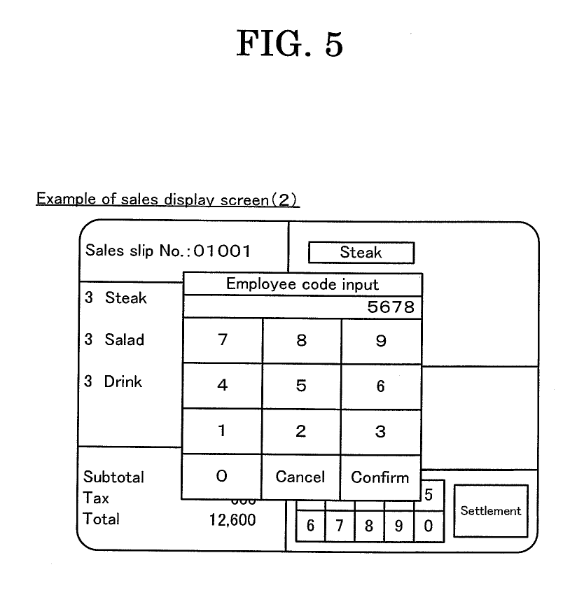

As a result of making a reference to the authorization level master table 13 as shown in FIG. 3, when it is determined that the casher has the necessary authority, the settlement operation is carried out by himself/herself. On the other hand, when it is determined that the casher has no authority to settle the transaction by himself/herself, an employee code input screen as shown in FIG. 5 is displayed on the display screen of the register terminal. Accordingly, the casher or the operator of the register terminal who is determined to have no authority to settle the transaction contacts his/her supervisor (for example his/her manager or the like) who has authority and asks the supervisor to come to the register terminal. FIG. 5 is an exemplified code input display on the screen for requesting the supervisor to input his/her code. The supervisor who comes to the register terminal and has higher authorization level pushes down (or touches) number input buttons displayed on the “code input column” for inputting his/her code, for example “5678” as the higher authority person for the casher.

When the appropriate code is inputted in the code input column on the code input display screen as shown in FIG. 5, a reference is made to the employee master table 12 as shown in FIG. 2 based upon the inputted employee code for conducting a search for the employee master information. Now, the number of the authorization level registered in the applicable employee master information is extracted. The authorization level master information is then extracted with reference to the authorization level master 13 as shown in FIG. 3 based upon the extracted authorization level master information. And the Yes/No flag in the extracted authorization level master information is seen to determine if he/she has authority to make settlement of any transaction in excess of the upper limit. If the authorization level of the person (manager or the like) who inputted his/her code has authority to settle the transaction, settlement processing is carried out and such settlement is tallied in report areas (i.e., registration areas in the time sequence report of settlements in excess of the upper limit and in the casher based report) to indicate that settlements in excess of the upper limit have been made.

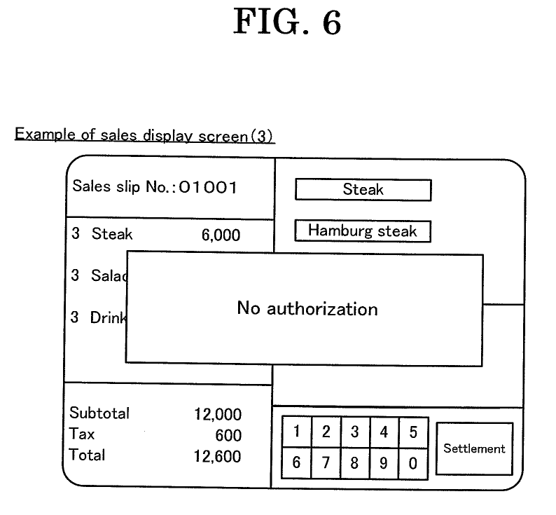

However, if the authorization level of the employee corresponding the inputted code is not permitted to settle the transaction, an error message such as “No Authorization” is displayed on the error display screen as shown in FIG. 6 and no settlement procedures are carried out. FIG. 6 is an exemplified error display screen for notifying that the casher has no authority to settle the transaction. It indicates that the employee corresponding to the code inputted in response to the employee code input display screen has no authority to settle any transaction in excess of the upper limit.

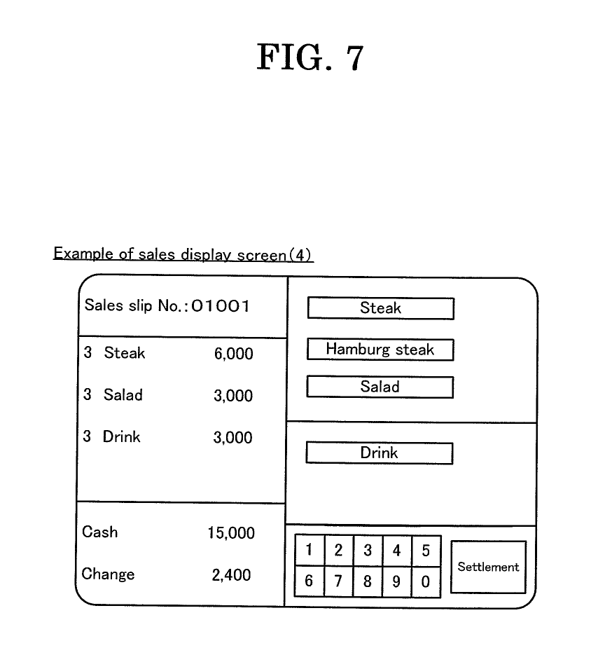

If the condition for settling transactions in excess of the upper limit is met, the settlement procedures are carried out and a settlement completion display screen appears on the display as shown in FIG. 7. FIG. 7 is an exemplified settlement completion display screen that appears on the display when the transaction settlement procedures have been completed. It shows the example that the total amount on the sales slip to be charged to the customer was 12,600 units as shown in FIG. 4 and the casher received cash equal to 15,000 units from the customer and 2,400 units were paid back to the customer as the change.

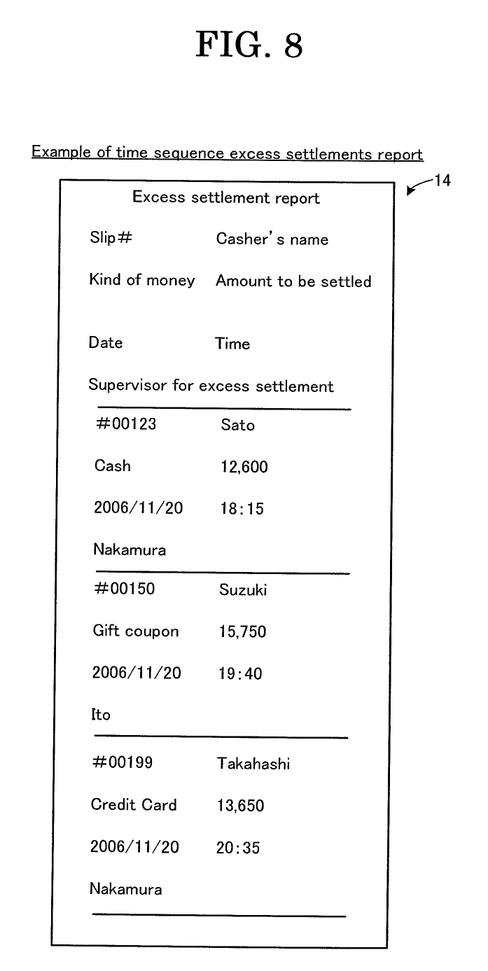

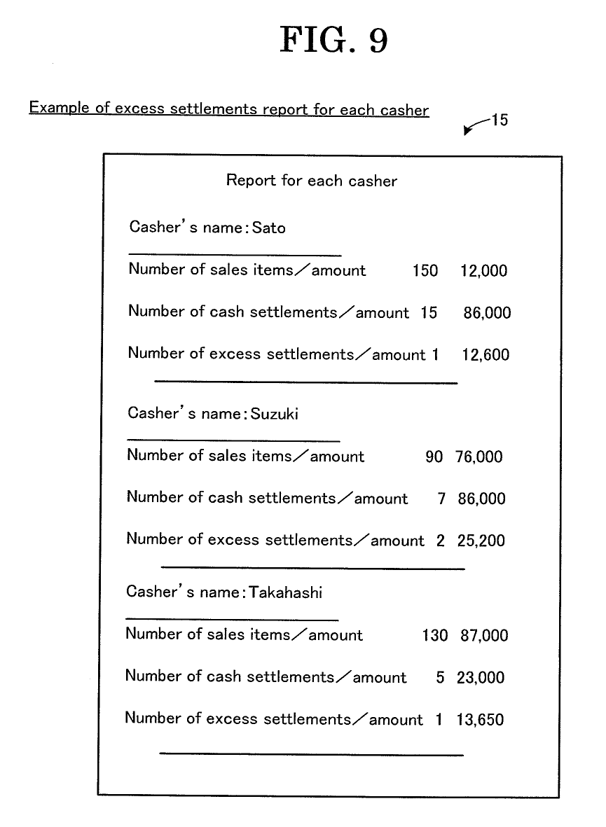

It is to be noted that histories of settlements for all transactions in excess of the upper limit are accumulated for excess settlement reports in time sequence and for each casher to be outputted at a predetermined period. FIGS. 8 and 9 show examples of such reports. That is, FIG. 8 is an example of the time sequence excess settlement report that lists histories of all excess settlements in the order of their occurrences. It sequentially lists all excess settlements in the order of processing times (in the particular example of the time sequence excess settlement report as shown in FIG. 8, there are excess settlements at 18:15, 19:40 and 20:35 on Nov. 20, 2006). The report includes names of the cashers, kinds of payment, amount of money and supervisors who approved respective excess settlements in form of a list.

On the other hand, FIG. 9 is an example of the casher based excess settlement report that lists histories of excess settlements made by each casher. For example, the report lists the total number of settlements made by each casher together with the total amount of money in the order of the cashers' employee codes (i.e., in the order of Sato, Suzuki and Takahashi in the particular example of the casher based excess settlement report 15). Also included in the report are the number of cash payments and the total amount of money by cash payments as well as the total number of excess settlements in excess of the upper limit (in the particular example of the casher based excess settlement report 15 as shown in FIG. 9, it includes the list of 1, 2 and 1 cases, 4 cases in total by Sato, Suzuki and Takahashi, respectively) together with the amount of money of each excess settlement.

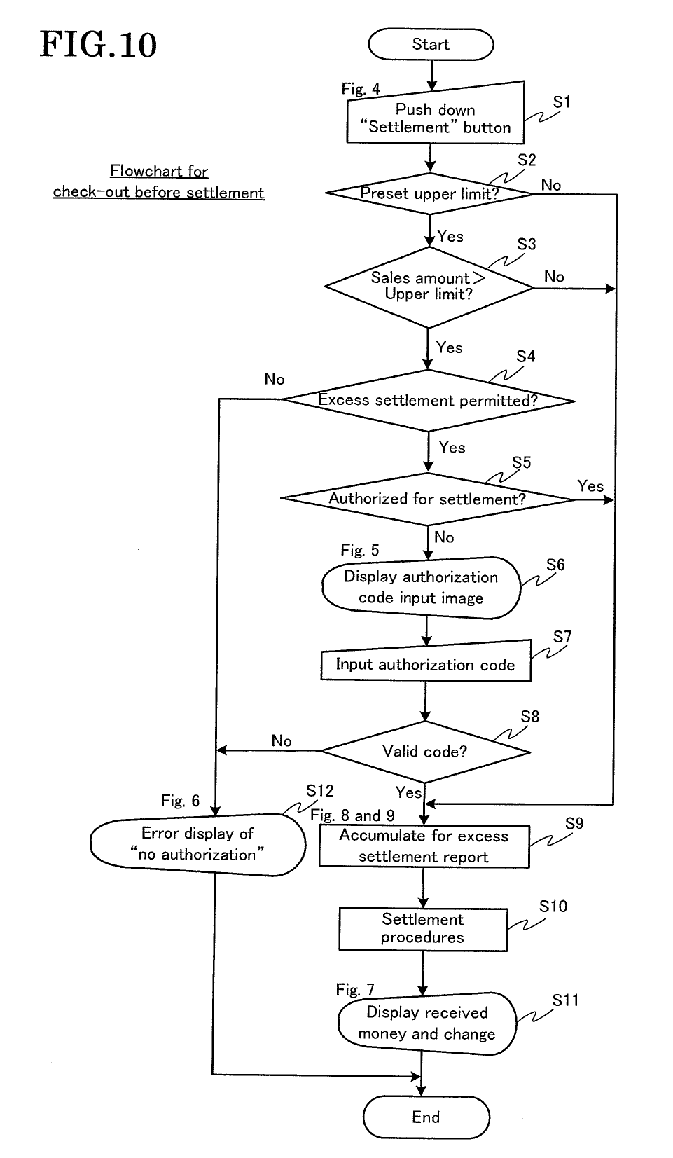

Finally, a further description will be made on the above described exemplified transaction settlement method according to the present invention with reference to the flowchart as shown in FIG. 10. FIG. 10 is an exemplified flowchart for describing the transaction settlement method according to the present invention.

In the flowchart as shown in FIG. 10, a sales display screen representing the sales slip is displayed on the screen of the register terminal. (In the particular example of the sales display screen as shown in FIG. 4, the total sales amount of money is 12,600 units as shown in the total column in the details of sales description display and is in excess of the upper limit of 10,000 units that is preset in the settlement master table in FIG. 1). And the casher who operates the register terminal pushes down the “Settlement” button (see step S1). Then, it is checked if the upper limit is preset in the settlement master table 11 as shown in FIG. 1 (see step S2). If no upper limit is preset (in case of “No” in step S2), it goes to step S9 for carrying out the settlement procedures. On the other hand, if the upper limit is preset (in case of “Yes” in step S2), it is checked if the amount of the total sales on the sales display screen exceeds the upper limit that is preset in the settlement master table 11 as shown in FIG. 1 (see step S3).

If the amount of the total sales on sales display screen is less than the upper limit (in case of “No” in step S3), it goes to step S9 for carrying out the settlement procedures. On the other hand, if the amount of the total sales on the sales display screen exceeds the upper limit (in case of “Yes” in step S3), it is checked if the settlement of the sales case can be made by the register terminal (see step S4). If it is determined that the sales case cannot be handled by the register terminal (in case of “No” in step S4), it goes to step 12 and an error display screen appears to indicate that no settlement can be made. On the other hand, if it is determined that the excess settlement can be made by the register terminal (in case of “Yes” in step S4), it is checked if the casher who operates the register terminal is authorized to make any excess settlement (see step S5).

If it is determined that the casher is authorized to make any excess settlement (in case of “Yes” in step S5), it goes to step S9 for carrying out the settlement procedures. On the other hand, if it is determined that the casher is not authorized to make any excess settlement (in case of “No” in step S5), displayed on the register terminal is the employee code input display screen, i.e., the authorization code input display screen as shown in FIG. 5 (see step S6). By providing the authorization code input display screen on the display, a supervisor having a higher authorization level than the current casher is called for. And he/she is asked to input his/her employee code as the authorization code in the “employee code input” column on the authorization code input display screen (see step S7).

Upon inputting the authorization code, it is checked if the inputted authorization code is valid for making any excess settlement (see step S8). If the inputted authorization code is determined invalid code for making any excess settlement (in case of “No” in step S8), displayed is an error display screen as shown in FIG. 6 to indicate that the person has no authority to make the excess settlement (see step S12) and terminates the procedures without carrying out the excess settlement. On the other hand, if it is determined that the inputted code is valid for making excess settlement (in case of “Yes” in step S8), excess settlement completion information to indicate that the excess settlement has been completed is accumulated in the time sequence excess settlement information report and the casher based excess settlement information report (see step S9) and the excess settlement procedures are carried out (see step S10). When the excess settlement has been completed, the settlement completion display screen as shown in FIG. 7 appears on the display and the cash received from the customer and the change are displayed on the register terminal (see step S11). And the casher who operates the register terminal hands the change and a receipt to the customer before terminating the settlement procedures.

### Advantages of the Present Embodiment

As described hereinabove in detail, the present embodiment enables to prevent cashers from making dishonest settlement operations by presetting an authorization level having a corresponding upper limit to each casher so that he/she can make settlement operations in accordance with the authorization level.

In case of making any settlement operation in excess of the upper limit, his/her supervisor (e.g., a manager or the like) having higher authorization level is called for to appear before the register terminal for inputting the supervisor's authorization code (e.g., an employee code or the like), thereby enabling the supervisor to recognize information about the customer who pays in excess of the upper limit before making the settlement procedures. Such useful information may be used for providing services to such customer before and after transaction settlement.

Although preferred embodiments of the present invention have been described hereinabove, such embodiments are nothing but examples of the present invention. It is to be understood for a person having an ordinary skill in the art that various modifications and alternations can be made best fit to particular applications without departing from the scope and spirit of the present invention. Accordingly, the scope of the invention should be restricted only by the appended claims.

What is claimed is:

1) A transaction settlement method for settling sales using a register terminal, characterized in that the upper limit of the amount of money to be permitted to settle by each casher who operates the register terminal is registered by arbitrarily setting in advance.

2) A transaction settlement method of claim 1, wherein if the amount of sales to be settled is in excess of the upper limit, an authorization level to indicate whether or not any sales in excess of the upper limit can be settled are registered in advance by arbitrarily setting for each casher.

3) A transaction settlement method of claim 2, wherein the authorization level comprises plural levels of combinations of not only the capability of excess settlement but also capabilities of other items including settlement of minus amount of money, zero amount of money and cancellation of sales slips.

4) A transaction settlement method of claim 1, wherein if the sales amount is in excess of the upper limit and the casher has no authority to make the excess settlement, an authorization code input display screen for prompting an alternative casher to input his/her authorization code is displayed on the screen of the register terminal.

5) A transaction settlement method of claim 4, wherein the alternative casher is permitted to settle the sales in excess of the upper limit using the register terminal if the authorization code inputted by the alternative casher while the authorization code input display screen is displayed proves to be valid for making the settlement in excess of the upper limit.

6) A transaction settlement method of claim 4, wherein if the authorization code inputted by the alternative casher is invalid for making the settlement in excess of the upper limit, no excess settlement procedures are carried out and an error message is displayed on the screen of the register terminal to indicate that he/she is not authorized to make the excess settlement.

7) A transaction settlement method of claim 1, wherein at the time of making the settlement in excess of the upper limit, histories of information on the excess settlement are stored as a time sequence excess settlement report and a casher based excess settlement report for outputting in form of a list.

8) A transaction settlement system for settling sales using a register terminal, characterized in the provision of means for arbitrarily registering in advance by setting upper limit of the amount of money that is permitted to settle by a casher who operates the register terminal.

9) A transaction settlement system of claim 8, characterized in the provision of casher registration means for registering in advance an authorization level to indicate whether or not the casher is permitted to make a settlement if the sales amount is in excess of the upper limit by arbitrarily setting the upper limit for each casher who operates the register terminal.

10) A transaction settlement system of claim 8, wherein an authorization code input display screen for prompting an alternative casher to input his/her authorization code is displayed on the register terminal if the sales amount exceeds the upper limit of the settlement amount and the casher has no authority to settle the account in excess of the upper limit.

11) A transaction settlement system of claim 10, wherein the register terminal of the casher is permitted to make the settlement of the sales amount in excess of the upper limit only if the authorization code inputted in response to the authorization code input display screen is the authorization code of any person having the authority to settle the sales amount in excess of the upper limit.

12) A transaction settlement system of claim 8, wherein at the time of making the settlement of any transaction in excess of the upper limit, histories on the excess settlements are accumulated for outputting in a list form a time sequence excess settlement report and/or an excess settlement report for each casher who operated the register terminal.

13) A transaction settlement program for performing the transaction settlement method of claim 1 in form of a computer executable program.

14) A program recording medium for recording the transaction settlement program of claim 13 in a computer readable recording medium.
